(19) United States
(12) Patent Application Publication
(10) Pub. No.: US 2022/0306124 A1
(43) Pub. Date: Sep. 29, 2022

(54) INFORMATION PROVIDING APPARATUS

(71) Applicant: HONDA MOTOR CO., LTD., Tokyo (JP)

(72) Inventors: Shinnosuke SATO, Saitama (JP); Takeshi MURO, Saitama (JP)

(21) Appl. No.: 17/578,499

(22) Filed: Jan. 19, 2022

(30) Foreign Application Priority Data
Mar. 24, 2021 (JP) 2021-049583

(51) Int. Cl. B60W 40/08; B60W 40/10

(52) U.S. Cl. CPC B60W 40/08; B60W 40/10; B60W 2040/0872; B60W 2540/01

(57) ABSTRACT

To notify facility information according to occupant scale information. An information providing apparatus is connected to an in-vehicle apparatus, a user mobile terminal, and a facility information database, and includes an information acquiring unit that acquires the current location and destination of a user and vehicle occupant information including occupant scale information from the in-vehicle apparatus or the user mobile terminal, a facility notification information selection unit that selects facility notification information to be notified to the user from the facility notification information based on at least one of current location information on the user or destination information on the user and preference information regarding the destination of the user, and a facility information notification unit that notifies the user terminal of the selected facility notification information. The facility notification information selection unit selects the facility notification information by means of the acquired vehicle occupant information.

This application is based on and claims the benefit of priority from Japanese Patent Application No. 2021-049563, filed on 24 Mar. 2021, the content of which is incorporated herein by reference.

### BACKGROUND OF THE INVENTION

### Field of the Invention

The present invention relates to an information providing apparatus that estimates, for a user of a vehicle such as an automobile, preference information changing according to the number of persons taking an action by means of information on the number of occupants and notifies the user of facility information according to the estimated user preference information.

### Related Art

Typically, in a case where facility information is provided to a vehicle such as an automobile, the facility information (e.g., coupon information) is delivered in a single uniform manner according to a distance from the current location of the vehicle. Thus, a user needs to search a facility matching the attribute of the user oneself from many pieces of delivered facility information (e.g., Patent Document 1).

Moreover, Patent Document 2 discloses a system in which in a case where facility information is provided to a vehicle such as an automobile, when a vehicle destination is, for example, set by a user of the vehicle, preference information on the user oneself in association with facilities on a movement route to the destination of the vehicle is read from an integrated information database and information on recommended facilities according to the preference information is provided to the user.
Patent Document 1: Japanese Unexamined Patent Application, Publication No. 2015-184072
Patent Document 2: Japanese Unexamined Patent Application, Publication No. 2019-138860

### SUMMARY OF THE INVENTION

In the system disclosed in Patent Document 1, the facility information (e.g., the coupon information) is delivered in the single uniform manner according to the distance from the current location of the vehicle. Thus, there is a risk of delivering facility information that differs to the needs of the customer, for example, providing counter-type restaurant information to families or providing family restaurant information to unmarried persons.

In the system disclosed in Patent Document 2, the preference information is, in some cases, different between a case where there is a single occupant and a case where an occupant is accompanied by one's family, for example. For example, tendency shows that buckwheat noodles, etc. are preferred in the case of the single occupant and a family restaurant is preferred in the case of the occupant with the family. For these reasons, there is a risk that information on facilities whose facility information matches preference according to the number of occupants and needs to be preferentially displayed for users is not efficiently provided according to the number of occupants.

The present invention has been made in view of the above-described problems. An object of the present invention is to provide an information providing apparatus that estimates, for a user of a vehicle such as an automobile, preference information which changes according to the number of persons taking an action by means of information on the number of occupants and provides the user with facility information according to the estimated user preference information.

(1) An information providing apparatus (e.g., a later-described “information providing apparatus 1”) for providing facility information to a user in a vehicle (e.g., a later-described “vehicle 5”) including a communication unit (e.g., a later-described “communication unit 13”), a storage unit (e.g., a later-described “storage unit 11”), and a control unit. (e.g., a later-described “control unit 10”), the information providing apparatus being, via the communication unit, communicably connected to a user terminal (e.g., a later-described “in-vehicle apparatus 2” and a later-described “user mobile terminal 3”) as a terminal used by the user and a facility information database (e.g., a later-described “facility information database server 6”) storing facility notification information including at least a facility name, a facility type, a facility provided service, and facility location information, the storage unit including a preference information storage management unit (e.g., a later-described “preference information storage management table 111”) that stores and manages preference information regarding the destination of the user in the storage unit, the control unit including an information acquiring unit (e.g., a later-described “information acquiring unit 101”) that acquires at least one of the current location of the user or the destination of the user from the user terminal via the communication unit, a notification information selection unit (a later-described “facility notification information selection unit 102”) that selects facility notification information to be notified to the user from the facility notification information stored in the facility information database based on at least one of current location information on the user or destination information on the user and the preference information regarding the destination of the user, and a notification unit (a later-described “facility information notification unit. 103”) that notifies the user terminal of the facility notification information selected by the notification information selection unit, the information acquiring unit further acquiring, for the user in the vehicle, vehicle occupant information including at least occupant scale information regarding the number of occupants in the vehicle, and the notification information selection unit further selecting the facility notification information to be notified to the user from the facility notification information stored in the facility information database by means of the user vehicle occupant information acquired by the information acquiring unit.

The information providing apparatus of (1) can estimate, for users of vehicles such as automobiles, the preference information changing according to the number of persons taking an action by means of the information on the number of occupants, and can provide the users with the facility information according to the estimated user preference information. Thus, user satisfaction is improved. Moreover, for a facility side, the hit rate to visit the facility is expected to be improved because the notification is made to users having a preference matching the characteristics of the facility.

(2) The information providing apparatus (e.g., the later-described “information providing apparatus 1”) according to (1), in which the vehicle occupant information includes at least occupant relationship information regarding a relationship among the occupants in the vehicle (e.g., the later-described “vehicle 5”).

According to the information providing apparatus of (2), the information on the relationship among the occupants is used, and therefore, preference information (e.g., a preference changes according to whether the occupants are a family or friends even in the case of the same number of occupants) changing the relationship among the occupants in addition to the number of persons taking an action can be estimated and the facility information according to the estimated user preference information can be provided to the users. Thus, user satisfaction is further improved. Moreover, for the facility side, the hit rate of hits as the destination to visit is expected to be further improved because the notification is made to the users having the preference matching the characteristics of the facility.

(3) The information providing apparatus (e.g., the later-described “information providing apparatus 1”) according to (1) or (2), further including a congestion information acquiring unit (e.g., the later-described “information acquiring unit 101”) that acquires congestion information on a facility located within a predetermined area from the current location based on the current location information on the user, in a case where the facility notification information selected by the notification information selection unit (e.g., the later-described “facility notification information selection unit 102”) is information on a facility providing a service, the notification unit (e.g., the later-described “facility information notification unit 103”) notifying the facility notification information together with congestion information on the facility.

According to the information providing apparatus of (3), the user can recognize a congestion status from the facility information, and therefore, it can be, according to the congestion status, determined whether or not the user will visit such a facility and user satisfaction is further improved.

(4) The information providing apparatus (e.g., the later-described “information providing apparatus 1”) according to any one of (1) to (3), the current location of the user being acquired by the information acquiring unit (e.g., the later-described “information acquiring unit 101”) and the notification unit (the later-described “facility information notification unit 103”) preferentially notifying the facility notification information in priority to a user whose distance or movement time calculated based on the current location information on the user and the facility location information is short.

According to the information providing apparatus of (4), the user can obtain the information on the closest facility. For such a facility, if the user has determined to visit the facility, user and facility satisfaction is further improved because user arrival time comes sooner.

(5) The information providing apparatus (e.g., the later-described “*information providing apparatus 1”) according to (4), the control unit (e.g., the later-described “control unit 10”) further including a biometric information acquiring unit (e.g., a later-described “biometric information acquiring unit 1015”) that acquires biometric information on the user from the user terminal (e.g., the later-described “in-vehicle apparatus 2” and the later-described “user mobile terminal 3”) via the communication unit (e.g., the later-described “communication unit 13”) and an evaluation unit (e.g., a later-described “facility evaluation unit 104”) that evaluates, in a case where the user visits a facility based on the notification information notified to the user by the notification unit (the later-described “facility information notification unit 103”), the facility from a change in the biometric information of the user between before and after the visit to the facility.

According to the information providing apparatus of (5), the biometric information of the occupant is further used when the facility information is selected according to the preference information corresponding to the information on the number of occupants, and therefore, the facility information suitable for the biometric information of the occupant can be provided.

(6) The information providing apparatus (e.g., the later-described “information providing apparatus 1”) according to (5), the control unit (e.g., the later-described “control unit 10”) further including a user abnormal state sensing unit (e.g., a “user abnormal state sensing unit 106”) that senses an abnormality, which includes at least worsening of a physical condition or occurrence of an accident of the user based on the biometric information if the user acquired by the biometric information acquiring unit (e.g., the later-described “biometric information acquiring unit 1015”) and an emergency processing unit (e.g., a later-described “emergency processing unit 107”) that notifies, in a case where a user abnormal state has been sensed by the user abnormal state sensing unit, the user abnormal state to a closest facility based on the user location information.

According to the information providing apparatus of (6), the occupant is promptly guided to the closest facility in response to worsening of the occupant physical condition, and therefore, treatment against worsening of the occupant physical condition can be promptly performed.

(7) The information providing apparatus (e.g., the later-described “information providing apparatus 1”) according to (6), the information acquiring unit (e.g., the later-described “information acquiring unit 101”) further acquiring vehicle velocity information including at least acceleration information and velocity information on the vehicle (e.g., the later-described “vehicle 5”) and the user abnormal state sensing unit (e.g., the later-described “user abnormal state sensing unit 106”) sensing the abnormality of the user based on the biometric information of the user acquired by the biometric information acquiring unit (e.g., the later-described “biometric information acquiring unit 1015”) and the vehicle velocity information acquired by the information acquiring unit.

According to the information providing apparatus of (7), when an accident such as a collision has occurred, such a situation is an extremely rare case for people involved, and it is difficult to take a quick action. With the provided functions, a quick action can be taken, including a call to related institutions.

(8) The information providing apparatus (e.g., the later-described “information providing apparatus 1”) according to (6) or (7), the control unit (e.g., the later-described “control unit 10”) further including an anomaly information recording management unit that accumulates, in the storage unit (e.g., the later-described “storage unit 11”), a date and location information when the user abnormal state sensing unit (e.g., the “user abnormal state sensing unit 106”) has sensed the abnormality of the user and an anomaly statistic recording management unit (e.g., a later-described “anomaly statistic recording management unit 109”) that produces the frequency of occurrence of the abnormality of the user and area information on an area where the abnormality has been sensed.

According to the information providing apparatus of (8), statistical processing can be performed for the information regarding the user abnormality and/or the vehicle (e.g., the later-described “vehicle 5”) anomaly, and a causal relationship with the biometric information of the user and the area information upon occurrence of the abnormality can be investigated, for example.

(9) The information providing apparatus (e.g., the later-described “information providing apparatus 1”) according to any one of (1) to (8), the control unit (e.g., the later-described “control unit 10”) further including a share car information acquiring unit (e.g., a later-described “share car information acquiring unit 101E”) that acquires facility notification information included in a share car information database (e.g., a later-described “share car information database server 8”) by cooperation of the user terminal (e.g., the later-described “in-vehicle apparatus 2” and the later-described “user mobile terminal 3”) with the share car information database and the notification information selection unit (the later-described “facility notification information selection unit 102”) further selecting the facility notification information by means of the facility notification information acquired by the share car information acquiring unit.

According to the information providing apparatus of (9), the user share car information is utilized so that the facility information more suitable for the user can be provided.

(10) An information providing method for providing facility information to a user in a vehicle by a computer including a communication unit (e.g., a later-described “communication unit 13”), a storage unit (e.g., a later-described “storage unit 11”) having a preference information storage management unit (e.g., a later-described “preference information storage management table 111”), and a control unit (e.g., a later-described “control unit 10”), the computer being, via the communication unit, communicably connected to a user terminal (e.g., a later-described “in-vehicle apparatus 2” and a later-described “user mobile terminal 3”) as a terminal used by the user in the vehicle and a facility information database (e.g., a later-described “facility information database server 6”) storing facility notification information including at least a facility name, a facility type, a facility provided service, and facility location information, the control unit performing the information acquiring step of acquiring at least one of the current location of the user or the destination of the user from the user terminal via the communication unit, the notification information selection step of selecting facility notification information to be notified to the user from the facility notification information stored in the facility information database based on at least one of current location information on the user or destination information on the user and the preference information regarding the destination of the user, and the notification step of notifying the user terminal of the facility notification information selected at the notification information selection step, the information acquiring step further including the step of acquiring, for the user in the vehicle, vehicle occupant information including at least occupant scale information regarding the number of occupants in the vehicle, and the notification information selection step further including the step of selecting the facility notification information to be notified to the user from the facility notification information stored in the facility information database by means of the user vehicle occupant information acquired at the information acquiring step.

According to the information providing method of (10), advantageous effects similar to those of (1) can be obtained.

According to the present invention, an information providing apparatus can be provided, which can estimate, for a user of a vehicle such as an automobile, preference information which changes according to the number of persons taking an action by means of information on the number of occupants and notify the user of facility information according to the estimated user preference information.

### BRIEF DESCRIPTION OF THE DRAWINGS

FIG. 1 is a diagram showing a system configuration of an information providing system;

FIG. 2 is a schematic diagram showing the configuration of an in-vehicle apparatus mounted on a vehicle;

FIG. 3 is a schematic diagram showing the configuration of a mobile terminal;

FIG. 4 is a schematic diagram showing the configuration of a biometric information acquiring terminal;

FIG. 5 is a schematic diagram showing the configuration of a facility information database server;

FIG. 6 is a schematic diagram showing the configuration of a facility terminal;

FIG. 7 is a schematic diagram showing the configuration of an information providing apparatus;

FIG. 8A is a flowchart showing the flow of the processing of the information providing apparatus;

FIG. 8B is a flowchart showing the flow of the processing of the information providing apparatus;

FIG. 8C is a flowchart showing the flow of the processing of the information providing apparatus; and

FIG. 8D is a flowchart showing the flow of the processing of the information providing apparatus.

### DETAILED DESCRIPTION OF THE INVENTION

### First Embodiment

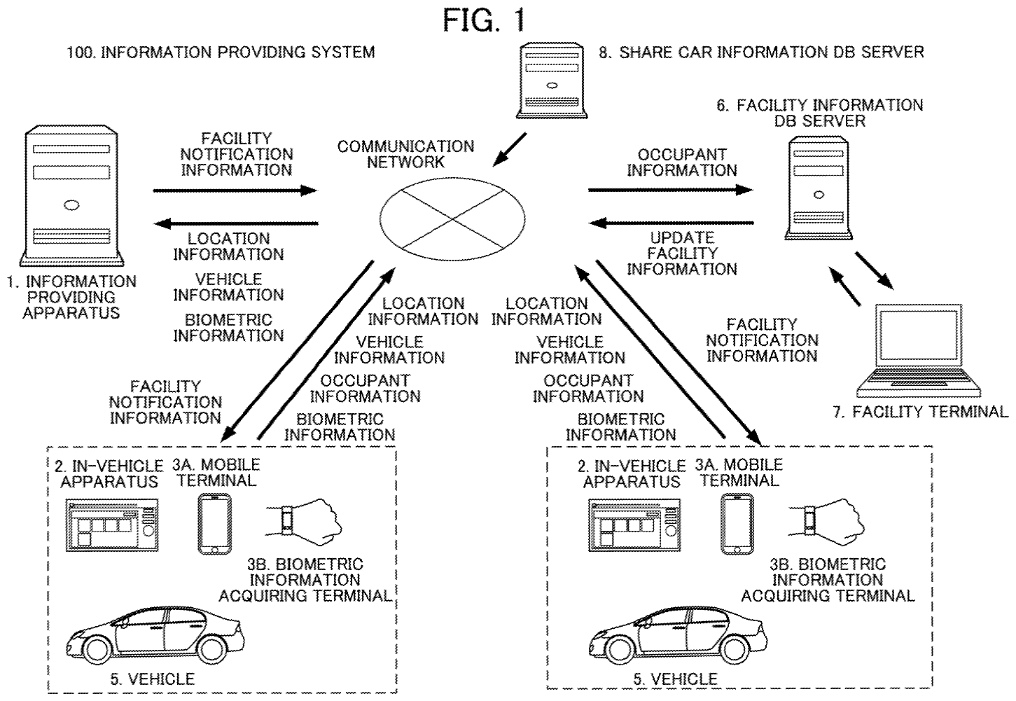

Hereinafter, one preferred embodiment of an information providing system of the present invention will be described with reference to FIGS. 1 to 8D.

### [Functional Configuration of Information Providing System 100]

A functional configuration of an information providing system 100 according to one preferred embodiment of the present invention will now be described. FIG. 1 shows a system configuration of the information providing system 100.

As shown in FIG. 1, the information providing system 100 includes an information providing apparatus 1, in-vehicle apparatuses 2 and user mobile terminals 3 as user terminals mounted on vehicles 5, a facility information database server 6, a facility terminal 7, and a share car information database server 8.

The vehicle 5 is realized by, for example, a four-wheeled automobile and a two-wheeled automobile. In the present embodiment, the four-wheeled automobile will be described as an example.

As described later, the information providing apparatus 1 is one type of server that exchanges information with the in-vehicle apparatus 2, the user mobile terminals 3, the facility information database server 6, etc. via a communication unit 12.

The in-vehicle apparatus 2 is an apparatus mounted on the vehicle 5, and may is realized by, for example, an in-vehicle navigation apparatus installed on the vehicle 5 and a PND placed on the vehicle 5 in a simple manner. Alternatively, the in-vehicle apparatus 2 may be in-vehicle equipment embedded in a center console panel of the vehicle 5 or a smartphone or a tablet temporarily attached to, e.g., a dashboard of the vehicle 5.

The user mobile terminal 3 includes, for example, a mobile terminal 3A such as a smartphone, a mobile phone, a tablet terminal, or a laptop computer; a biometric information acquiring terminal 3B as a wearable terminal including a smart watch; and other types of electronic equipment portable by users and having a wireless communication function. Note that in the present embodiment, the user mobile terminal 3 is a terminal carried by a user in the vehicle 5, and includes the mobile terminal 3A and the biometric information acquiring terminal 3B such as the smart watch.

As described later, the facility information database server 6 is one type of database server having the functions of recording and managing facility notification information and providing the facility notification information to the in-vehicle apparatuses 2 and the user mobile terminals 3.

The facility terminal 7 can access, using a terminal utilized by a facility manager, the facility information database server 6 or the information providing apparatus 1 via a network, thereby generating or updating facility information including the facility notification information from the facility manager, for example. Alternatively, information on the user to which the facility information is notified may be received from the information providing apparatus 1.

The information providing apparatus 1 exchanges information with the in-vehicle apparatuses 2, the user mobile terminals 3, and the facility information database server 6 via the communication unit 12. The information providing apparatus 1 extracts, based on current location information and mobile type information on the vehicle 5, a plurality of facilities located from the current location of the vehicle 5 to the vicinity thereof in a travelling direction and a plurality of facilities according to vehicle occupant information including occupant scale information on occupants in vehicles in the vicinity of a route from the current location of the vehicle 5 to a destination, thereby delivering (hereinafter also referred to as “notify”) such information to the in-vehicle apparatus 2 and the user mobile terminal 3. With this configuration, the information providing apparatus 1, the in-vehicle apparatus 2, or the user mobile terminal 3 may generate, based on a facility selected by the user, route information targeted for such a facility as the destination, thereby guiding the user.

In the embodiment of the present invention, the information providing apparatus 1 is described as, e.g., one server, but may be a distributed processing system for distributing the functions of the information providing apparatus 1 to a plurality of servers as necessary. In this case, the in-vehicle apparatus 2 or the mobile terminal 3A may have some of the functions of the information providing apparatus 1. Alternatively, each function of the information providing apparatus 1 may be implemented utilizing, e.g., a virtual server function on the cloud. Details of the information providing apparatus 1 will be described later.

First, the in-vehicle apparatus 2 and the user mobile terminal 3 (the mobile terminal 3A and the biometric information acquiring terminal 3B) will be described.

### <In-Vehicle Apparatus 2>

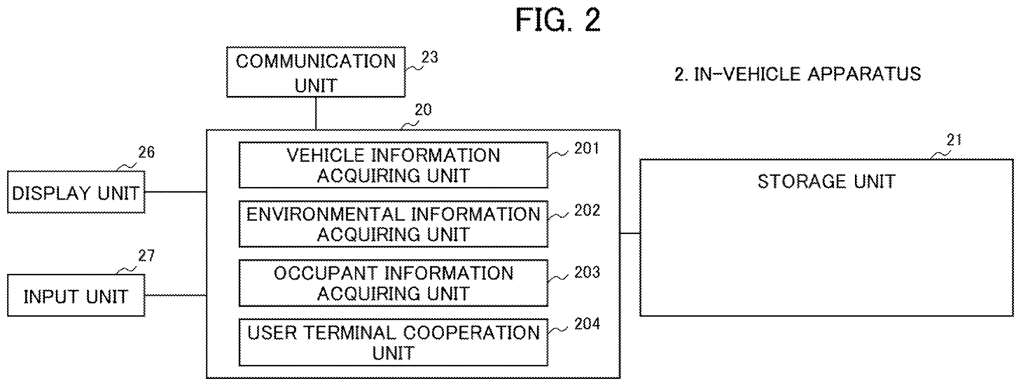

The in-vehicle apparatus 2 mounted on the vehicle 5 may is realized by, for example, an in-vehicle navigation apparatus installed on the vehicle 5 and a PND placed on the vehicle 5 in a simple manner. Alternatively, the in-vehicle apparatus 2 may be an in-vehicle apparatus embedded in the center console panel of the vehicle 5 or a smartphone or a tablet temporarily attached to, e.g., the dashboard of the vehicle 5. In the present embodiment, the in-vehicle apparatus 2 will be, as one example, hereinafter described as the in-vehicle equipment embedded in the center console panel of the vehicle 5. FIG. 2 is a schematic diagram showing the configuration of the in-vehicle apparatus 2 mounted on the vehicle 5.

The in-vehicle apparatus 2 includes, for example, a control unit 20, a storage unit 21, a communication unit 23, a display unit 26, and an input unit 27. For example, software for implementing an information providing function and a route guide function (a car navigation function) may be installed on the storage unit 21 in advance. Alternatively, the software may be downloaded as necessary upon information exchange with the information providing apparatus 1.

The control unit 20 includes a microprocessor, etc. The control unit 20 executes various programs stored in the storage unit 21, thereby causing the in-vehicle apparatus 2 to function as various sections described below.

The communication unit 23 can exchange information with the mobile terminal 3A, the biometric information acquiring terminal 3B, and the information providing apparatus 1 via wireless communication. The communication unit 23 can exchange information with the mobile terminal 3A and the biometric information acquiring terminal 3B via near field wireless communication such as Bluetooth (the registered trademark). Moreover, the communication unit 23 can exchange information with the information providing apparatus 1 via wireless communication via a network NC, such as a wireless LAN including Wi-Fi (the registered trademark). With this configuration, the in-vehicle apparatus 2 can transmit vehicle information, etc. on a regular basis or in response to a request from the information providing apparatus 1.

The display unit 26 includes a display device such as a liquid crystal display or an organic EL panel, and displays an image in response to an instruction from the control unit 20. The display unit 26 can display various types of information including, for example, the current location of the vehicle 5, map information on the periphery of the current location of the vehicle 5 read from the storage unit 21, the facility information acquired from the information providing apparatus 1 via the communication unit 23 and including a displaying order, the destination set by the user, and the route information.

The input unit 27 includes, for example, an input apparatus (not shown) such as a physical switch called a numeric key or a touch panel provided on a display surface of the display unit 26. A signal based on operation input via the input unit 27, such as pressing of the numeric key or touching of the touch panel by the user, is output to the control unit 20 so that, e.g., the operation of scrolling the displayed facility information, determining a facility that the user will stop by, and zooming in or out of a map can be performed.

The control unit 20 will now be described. As shown in FIG. 2, the control unit 20 includes a vehicle information acquiring unit 201, an environmental information acquiring unit 202, an occupant information acquiring unit 203, and a user terminal cooperation unit 204.

### <Acquisition of Various Types of Sensor Information>

The in-vehicle apparatus 2 (the vehicle information acquiring unit 201) can acquire sensor information acquired by various sensors provided on the vehicle 5 via an in-vehicle LAN including, e.g., wired, wireless, and near field communication such as Bluetooth (the registered trademark).

The in-vehicle apparatus 2 can acquire, e.g., the current location information on the vehicle 5, travelling distance information on the vehicle 5, velocity information on the vehicle 5, acceleration information on the vehicle 5, airbag operation information on the vehicle 5, vehicle impact information indicating that impact has been applied to the vehicle 5, sudden braking information indicating that a brake of the vehicle 5 has been stepped on, vehicle start/stop information on the vehicle 5, and door lock information on the vehicle 5 by, e.g., a GPS sensor, a vehicle velocity sensor, an acceleration sensor, an airbag sensor, an impact sensor, a sudden braking sensor, an ignition switch ON/OFF detection sensor, and a door lock sensor provided on the vehicle 5. Moreover, the in-vehicle apparatus 2 can acquire user destination information by the navigation function, for example.

Further, the in-vehicle apparatus 2 (the environmental information acquiring unit 202) can acquire external environmental information including, e.g., an air temperature, a humidity, an air pressure, and a brightness outside the vehicle 5 by, e.g., a temperature sensor, a humidity sensor, an air pressure sensor, and an illumination sensor provided on the vehicle 5.

Similarly, the in-vehicle apparatus 2 can acquire internal environmental information including, e.g., a carbon dioxide concentration, an air temperature, a humidity, an air pressure, and a brightness inside a vehicle compartment of the vehicle 5 by, e.g., a carbon dioxide concentration sensor, an internal temperature sensor, an internal humidity sensor, an internal air pressure sensor, and an internal illumination sensor provided on the vehicle 5.

A plurality of seating sensors that sense whether or not an occupant is seated on each seat is provided on the vehicle 5. Moreover, a seatbelt sensor that senses connection of a seatbelt provided on each seat is provided. The in-vehicle apparatus 2 (the occupant information acquiring unit 203) can detect the number of occupants in the vehicle 5 based on the sensor information sensed by the seating sensors or the seatbelt sensors.

A camera (an imaging sensor) placed in the vicinity of, e.g., a rearview mirror or a front window of the vehicle 5 to capture internal and external images of the vehicle 5 may be communicably connected Co the in-vehicle apparatus 2. Moreover, a camera (an imaging sensor) provided corresponding to each seat location in the vehicle 5 and arranged at such a location that a facial image of an occupant seated at each seat location can be captured, a driver seat camera (an imaging sensor), and a passenger seat camera (an imaging sensor) may be communicably connected to the in-vehicle apparatus 2. The in-vehicle apparatus 2 (the occupant information acquiring unit 203) may execute, e.g., facial recognition processing by means of image data captured by these cameras (the imaging sensors), thereby determining the number of occupants in the vehicle 5 and the gender and estimated age of each occupant.

With this configuration, the in-vehicle apparatus 2 (the occupant information acquiring unit 203) can assume an occupant relationship, such as a family or parent-child relationship or a friend or colleague relationship, according to the number of occupants and the gender and estimated age of each occupant, thereby sensing occupant relationship information. Specifically, for example, in a case where the number of occupants in the vehicle is two and there are one male and one female which are not children, these occupants can be estimated as a “couple”. In a case where the number of occupants in the vehicle 5 is three or more, there are at least one male adult and one female adult, and there is at least one child, these occupants can be estimated as a “family”.

A sound collection apparatus (a microphone) placed on the vehicle 5 to collect the voice of an occupant may be communicably connected to the in-vehicle apparatus 2. The in-vehicle apparatus 2 (the occupant information acquiring unit 203) analyzes occupant conversation information by means of voice data collected by the sound collection apparatus (the microphone) so that information on an occupant's facility evaluation can be detected.

Specifically, e.g., a well-known voice recognition algorithm is used to extract and recognize a keyword in the voice of the voice data so that information regarding an occupant can be estimated based on the recognized keyword. For example, if a keyword such as “tasted good”, “enjoyed”, “fun”, or “want to come again” is obtained for a facility that the user has visited, user's positive evaluation on such a facility can be estimated based on the keyword. Conversely, if a keyword such as “not taste good”, “tasted bad”, “not fun”, or “not want to come again” is obtained, user's negative evaluation on such a facility can be estimated based on the keyword.

The in-vehicle apparatus 2 (the user terminal cooperation unit 204) can sense the user mobile terminals 3 present in the vehicle compartment of the vehicle 5, the user mobile terminals 3 including the mobile terminal 3A such as a smartphone and the biometric information acquiring terminal 3B such as a smart watch. Specifically, the in-vehicle apparatus 2 outputs a response request signal by means of near field wireless communication targeted for the inside of the vehicle compartment of the vehicle 5, for example. In response to the response request signal, if response signals are output from the user mobile terminals 3 present in the vehicle compartment, such as the mobile terminal 3A and the biometric information acquiring terminal 3B, the in-vehicle apparatus 2 may receive these response signals to sense that the user mobile terminals 3 such as the mobile terminal 3A and the biometric information acquiring terminal 3B are present in the vehicle compartment of the vehicle 5.

The in-vehicle apparatus 2 (the user terminal cooperation unit 204) may exchange information with the mobile terminal 3A and the biometric information acquiring terminal 3B in the vehicle compartment via the in-vehicle LAN (near field wireless communication such as Bluetooth (the registered trademark)). For example, the in-vehicle apparatus 2 (the user terminal cooperation unit 204) may receive terminal information including terminal identification information on each terminal from the user mobile terminals 3 present in the vehicle compartment, such as the mobile terminal 3A and the biometric information acquiring terminal 3B. With this configuration, the in-vehicle apparatus 2 may transmit, to the information providing apparatus 1, identification information on the vehicle 5 and the vehicle occupant information including the terminal identification information on each user mobile terminal 3 (e.g., the mobile terminal 3A and the biometric information acquiring terminal 3B) via the communication unit 23. With this configuration, the information providing apparatus 1 can process information exchanged with the mobile terminal 3A and the biometric information acquiring terminal 3B as the vehicle occupant information on the vehicle in the case of communicating with the mobile terminal 3A and the biometric information acquiring terminal 3B as the user mobile terminals 3 present in the vehicle compartment.

Moreover, the in-vehicle apparatus 2 (the user terminal cooperation unit 204) generates the vehicle occupant information on the vehicle 5 based on the information exchanged with, e.g., the mobile terminal 3A and the biometric information acquiring terminal 3B as the user mobile terminals 3 present in the vehicle compartment, so that the generated vehicle occupant information can be transmitted to the information providing apparatus 1.

### <Mobile Terminal 3A>

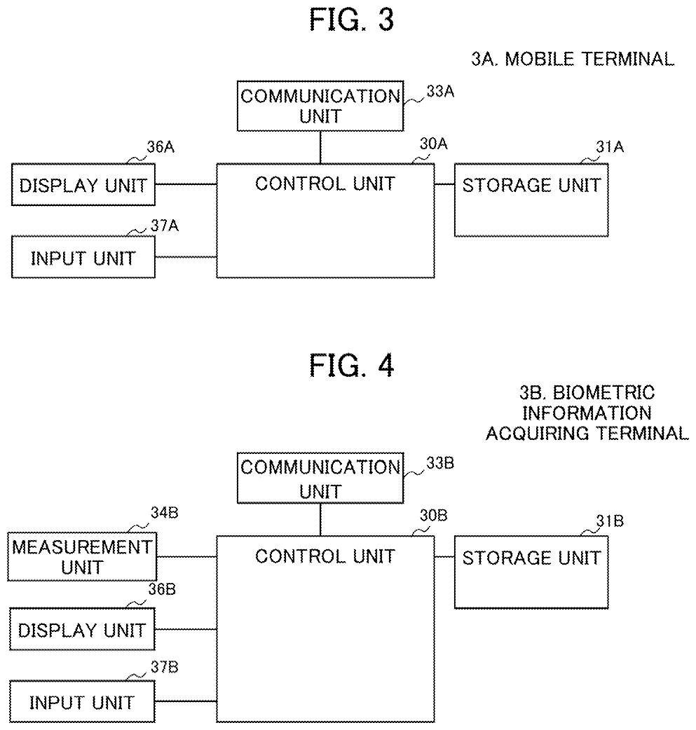

The mobile terminal 3A is, for example, a smartphone, a mobile phone, a tablet terminal, a PDA, a laptop computer, or other types of portable electronic equipment, and includes electronic equipment having a wireless communication function. As in the in-vehicle apparatus 2, the mobile terminal 3A can also display the facility information notified from the information providing apparatus 1. Note that as described above, functions similar to those of the in-vehicle apparatus 2 may be implemented instead of the in-vehicle apparatus 2 in such a manner that the mobile terminal 3A (e.g., a smartphone) is temporarily attached to, e.g., the dashboard of the vehicle 5 and pairing of the mobile terminal 3A with, e.g., the vehicle 5 is performed. In this case, the mobile terminal 3A can have functions equivalent to those of the in-vehicle apparatus 2. FIG. 3 is a schematic diagram showing the configuration of the mobile terminal 3A.

As in the in-vehicle apparatus 2, the mobile terminal 3A includes a control unit 30A, a storage unit 31A, a communication unit 33A, various sensor units 34A, a display unit 36A, and an input unit 37A.

The control unit 30A includes a versatile processor such as a CPU, and as the mobile terminal 3A, executes various types of control according to various programs stored in the storage unit 31A in advance.

The storage unit 31A stores various programs, etc. An image generated by the control unit is displayed on the display unit 36A.

Various sensor units 34A include, for example, a GPS sensor, a geomagnetic sensor, an acceleration sensor, a gyroscope sensor, and an illumination sensor.

The communication unit 33A can exchange information with the in-vehicle apparatus 2, the biometric information acquiring terminal 3B, and the information providing apparatus 1 via wireless communication. The communication unit 33A can exchange information with the in-vehicle apparatus 2 and the biometric information acquiring terminal 3B via near field wireless communication such as Bluetooth (the registered trademark). Moreover, the communication unit 33A can exchange information with the information providing apparatus 1 via wireless communication via the network NC, such as a wireless LAN including Wi-Fi (the registered trademark).

Note that as described above, the functions of the in-vehicle apparatus can be implemented in such a manner that the mobile terminal 3A such as a smartphone or a tablet is temporarily attached to, e.g., the dashboard of the vehicle 5. As described above, the mobile terminal 3A has functions equivalent to those of the above-described in-vehicle apparatus 2.

### <Biometric Information Acquiring Terminal 3B>

FIG. 4 is a schematic diagram showing the configuration of the biometric information acquiring terminal 3B. The biometric information acquiring terminal 3B means electronic equipment attachable to or wearable by the user, and also means a terminal having the function of acquiring biometric information on such a user. In the present embodiment, a wearable terminal capable of measuring the biometric information, such as a smart watch, is described as an example.

The biometric information acquiring terminal 3B includes, as in the in-vehicle apparatus 2 and the mobile terminal 3A, a control unit 30B, a storage unit 31B, a communication unit 33B, and a display unit 36B, and further includes a measurement unit 34B.

The control unit 30B includes a versatile processor such as a CPU, and as the biometric information acquiring terminal 3B, executes various types of control according to various programs stored in the storage unit 31B in advance.

The storage unit 31B stores, e.g., various programs, the terminal identification information for identifying the terminal, and the biometric information of the user measured by a later-described measurement unit (not shown). An image (e.g., a biometric information measurement result and time information) generated by the control unit is displayed on the display unit 36B.

The communication unit 33B can exchange information with the in-vehicle apparatus 2, the mobile terminal 3A, and the information providing apparatus 1 via wireless communication. The communication unit 33B can exchange information with the in-vehicle apparatus 2 and the mobile terminal 3A via near field wireless communication such as Bluetooth (the registered trademark). Moreover, the communication unit 33B can exchange information with the information providing apparatus 1 via wireless communication via the network NC, such as a wireless LAN including Wi-Fi (the registered trademark). For example, the communication unit 33B can transmit the biometric information of the user to the information providing apparatus 1 on a regular basis or in response to a request from the information providing apparatus 1.

The measurement unit 34B is a biosensor that contacts a user's body to measure the biometric information of the user. The measurement unit 34B may include a biosensor capable of measuring, as the biometric information, at least any of a heart rate, an electrocardiogram, a blood pressure, a body temperature, a blood oxygen level, a respiration rate, a respiration cycle, a sweating amount, a pulse amplitude, a blood glucose level, and a sleeping condition in association with a user's body condition. With this configuration, the measurement unit 34B can constantly measure the biometric information of the user.

### <Facility Information Database Server 6>

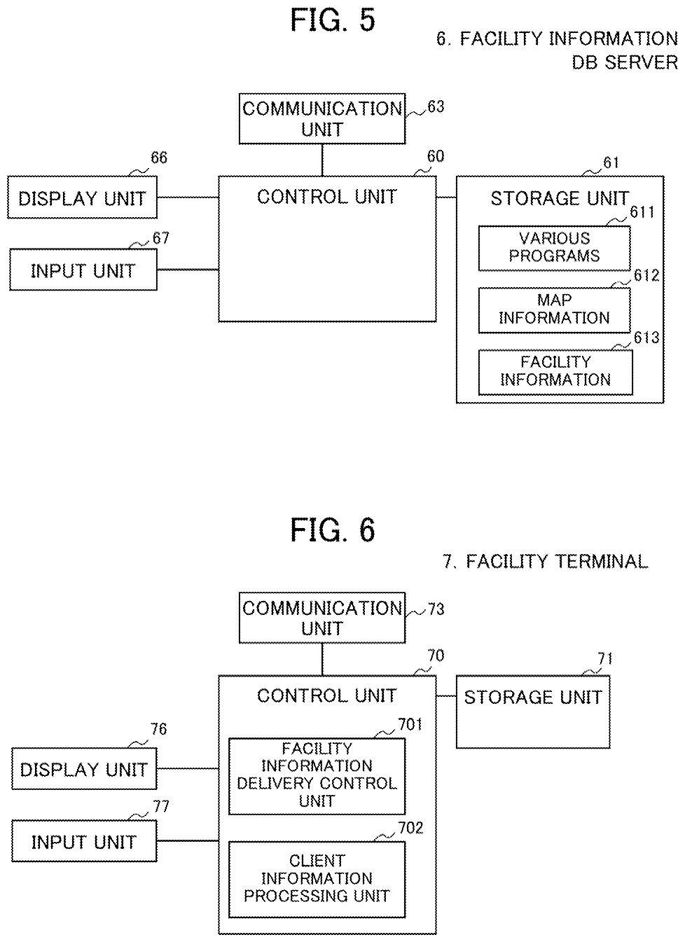

FIG. 5 is a schematic diagram showing the configuration of the facility information database server 6.

As shown in FIG. 5, the facility information database server 6 includes at least a control unit 60, a storage unit 61, and a communication unit 63, and as necessary, further includes a display unit 66 and an input unit 67.

The control unit 60 includes a processor having a CPU, a RAM, a ROM, an I/O, etc., and controls each component. The CPU executes each program read from the RAM, the ROM, or the storage unit 61, thereby executing, as the facility information database server, various types of control. Specifically, the control unit 60 provides an access interface for information stored in a facility information database to the information providing apparatus 1, the in-vehicle apparatuses 2, the user mobile terminals 3, and the facility terminal 7. Accordingly, the information providing apparatus 1, the in-vehicle apparatuses 2, the user mobile terminals 3, and the facility terminal 7 can search, refer to, or update the information stored in the facility information database server 6, for example.

The storage unit 61 stores various programs 611, map information 612, facility information 613, etc.

The map information 612 includes, for example, information regarding features such as a road or a facility and map information, road information, facility location information, and parking information for navigation. The map information may include, for example, display map data for displaying a background such as a road and a road map, node (e.g., a road intersection, a road folding point, or a road end point) location and type information, location and type information on a link as a route connecting nodes, and road network data including link cost data, etc. regarding cost information (e.g., a distance and required time) on all links.

The road information may include so-called road map information such as a road type and a traffic light.

The facility location information links facility identification information (hereinafter also referred to as a “facility ID”), and includes facility location information saved as latitude-longitude information.

The parking information includes parking location information saved as latitude-longitude information. In a case where a parking location is a parking location for each facility, the facility and the parking location are saved linking each other.

The facility information 613 includes, for example, the facility identification information (the facility ID), a name, a facility type (and/or a category), a telephone number, an address, business hours, and location information specified by, e.g., a latitude and a longitude, and if such a facility is a restaurant, includes, for example, a menu to be provided, facility information regarding goods and services, etc., the goodness-of-fit for each user attribute of a service provided by a facility, and coupon issuance information. Note that the facility information may include a facility status (e.g., congestion information on a facility in each time period, the status of reservation of a facility by each user, and reservation information indicating an availability, etc.) for each facility ID. The facility information may further include facility evaluation information provided to such a facility.

The degree of suitability of the service provided by the facility according to each user attribute means a frequency in relative evaluation on the degree of fitting of the facility according to each user attribute. The user attribute is such attribute information that users are classified based on the scale (the number of users) of users visiting the facility, the gender of each user, the age group of each user, and a user relationship (e.g., a family, a couple, or friends).

For example, in a case where the facility is a restaurant, the degree of suitability is a frequency indicating the degree of fitting of service contents (e.g., a menu, a seat layout, and atmosphere) provided by such a restaurant according to each user attribute.

For example, in a case where the restaurant is targeted for females and families, the degree of suitability may be set in advance for each user group, such as the degree of suitability for females being 60, the degree of suitability for families being 30, and the degree of suitability for anniversaries being 10. Note that in addition to above, the user attribute includes, for example, elders and males, but the present invention is not limited to above.

The degree of suitability as described above may be directly input to an information record of the facility itself via the later-described facility terminal 7 by, e.g., a facility manager.

Accordingly, the information providing apparatus 1 can select a facility matching a corresponding user attribute of an occupant by means of the vehicle occupant information, as described later.

### <Facility Terminal 7>

Next, the outline of the facility terminal 7 will be described. FIG. 6 is a schematic diagram showing the configuration of the facility terminal 7. As shown in FIG. 6, the facility terminal 7 includes at least a control unit 70, a storage unit 71, a communication unit 73, a display unit 76, and an input unit 77. The configuration of each unit is, for example, similar to those of corresponding units of the mobile terminal 3A and the information providing apparatus 1.

The control unit 70 executes each program, thereby causing the facility terminal 7 to function as a predetermined section (hereinafter collectively referred to as a “facility information delivery control unit”).

Moreover, the control unit 70 executes each program for facility information delivery control, thereby causing the facility terminal 7 to execute a predetermined step (hereinafter collectively referred to as a “facility information delivery control step”).

### <Facility Information Delivery Control Unit 701>

A facility information delivery control unit 701 can produce and update in real time, based on, e.g., input from the facility manager, the contents of the facility information (e.g., the effective period of the facility information, delivered image information, goods and service information, coupon information, and an availability), conditions regarding delivery of the facility information (e.g., the effective period of the facility information and a period of time for delivering the facility information), the degree of suitability for each user group of the service provided by the facility, and etc., which are stored in the facility information database server 6.

With this configuration, the facility manager can notify the latest facility information to a target user group of the facility, for example. Moreover, the facility manager can set a condition regarding notification of the facility information such that the information providing apparatus 1 does not deliver the facility information in a case where the facility is crowded, for example.

Further, the facility manager can timely set, for sales promotion, the delivered image information, the coupon information, the availability, etc., for example.

In addition, the facility manager can set, e.g., the degree of suitability of the service provided by the facility according to each user group for sales promotion for a particular user group.

### <Client Information Processing Unit 702>

A client information processing unit 702 may receive, from the information providing apparatus 1, client information (e.g., distribution of users (vehicles), whose preference information matches the characteristics of the facility, in the vicinity of the facility, information on a vehicle set to the facility as a destination, and the expected arrival time of such a vehicle). With this configuration, the facility manager can predict visitors and promote sales, for example.

Next, the share car information database server 8 will be described.

The share car information database server 8 is one type of big data including, for example, analyzed information on a facility visited by a user utilizing a share car, such as information on a facility frequently visited by a user utilizing a share car and information on a facility frequently visited by a user matching predetermined preference information.

As described later, in a case where there are many (a predetermined number or more) pieces of facility notification information selected for a certain user, if there is a facility frequently visited by a user group whose preference information is the same as that of the certain user by means of a share car, the information providing apparatus 1 may cooperate with the share car information database server 8 to notify such facility notification information from the pieces of facility notification information.

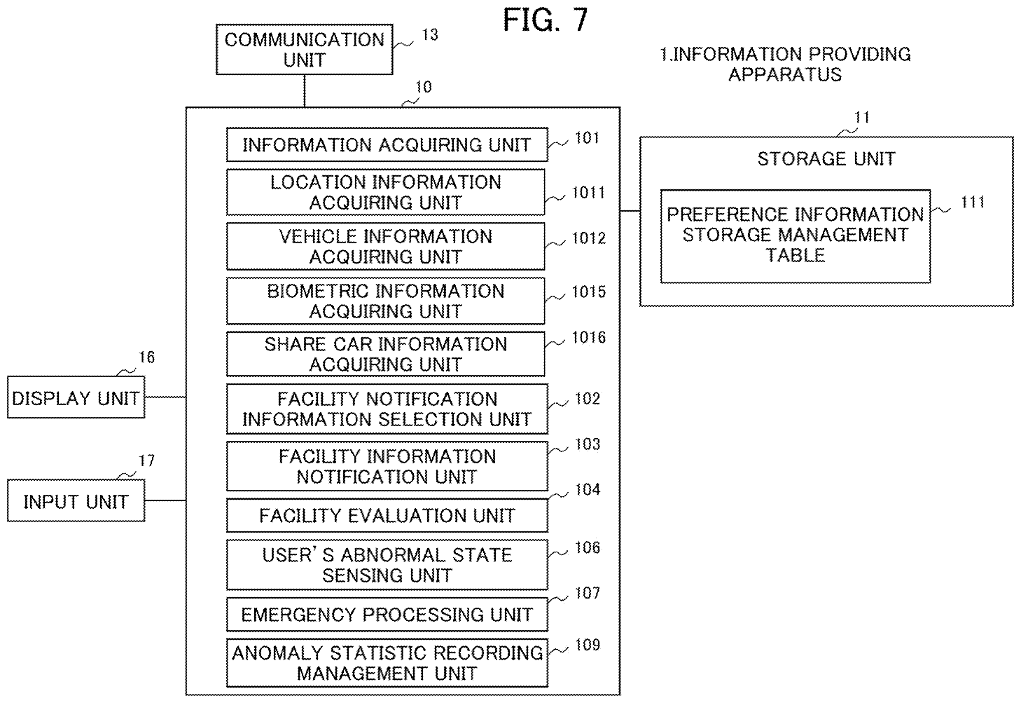

Finally, the information providing apparatus 1 as an information providing apparatus will be described. FIG. 7 is a schematic diagram showing the configuration of the information providing apparatus 1.

### <Information Providing Apparatus 1>

As shown in FIG. 7, the information providing apparatus 1 includes at least a control unit 10, a storage unit 11, and a communication unit 13, and as necessary, includes a display unit 16 and an input unit 17.

The control unit 10 includes a processor having a CPU, a RAM, a ROM, a I/O, etc. The control unit 10 executes each program, thereby causing the information providing apparatus 1 to function as a predetermined section (hereinafter collectively referred to as an “information providing control unit”). Details will be described later.

The storage unit 11 includes a semiconductor memory, a hard disk drive, etc., and stores various types of information such as an operating system (OS) and software called an application. Specifically, the storage unit 11 stores, for example, information on a facility at which a vehicle stays, evaluation information on the facility at which the vehicle stays, and anomaly occurrence information. Moreover, the storage unit 11 stores and manages, for example, the identification information on the in-vehicle apparatus 2 and the user mobile terminals 3 (the mobile terminal 3A, the biometric information acquiring terminal 3B).

Further, the storage unit 11 may store, for grasping the current location of the moving vehicle 5, the location information, the time information, and the destination information transmitted on a regular basis from the in-vehicle apparatus 2 or the user mobile terminals 3, the travelling direction, etc. of the vehicle 5, and the state (e.g., an ignition-ON state, a travelling state, or an ignition-OFF state) of the vehicle in a connection history record managed using the identification information on the in-vehicle apparatus 2.

Note that as described above, the identification information on the user mobile terminals 3 (the mobile terminal 3A, the biometric information acquiring terminal 3B) present in the vehicle compartment of the vehicle 5 may be stored and managed as an occupant on the same vehicle with such identification information linking the identification information on the in-vehicle apparatus 2 during movement, and the information exchanged as the same occupant may be stored and managed as the vehicle information, for example.

As described above, the storage unit 11 may store user attribute-preference information correspondence information (a preference information storage management table 111) indicating correspondence between the user attribute estimated based on the vehicle occupant information and, e.g., a facility type or category (also referred to as “preference information”) with a high degree of suitability. For example, in the case of a family, a restaurant having a table or a tatami room where the family can sit together and providing many types of meals as food is assumed to have, as a food-and-beverage facility, a high degree of suitability.

The communication unit 13 is equipped with a communication protocol for wired communication (e.g., Internet connection) or wireless communication so as to communicate with the in-vehicle apparatuses 2, the user mobile terminals 3, the facility information database server 6, the facility terminal 7, the share car information database server 8, etc.

Next, the functions of the control unit 10 will be described in terms of the information providing control unit.

As shown in FIG. 7, the control unit 10 includes an information acquiring unit 101, a facility notification information selection unit 102, a facility information notification unit 103, a facility evaluation unit 104, a user abnormal state sensing unit 106, an emergency processing unit 107, and an anomaly statistic recording management unit 109.

### <Information Acquiring Unit 101>

The information acquiring unit 101 acquires various types of information from the in-vehicle apparatuses 2, the user mobile terminals 3 (the mobile terminal 3A, the biometric information acquiring terminal 3B, etc.), and the facility information database server 6 via the communication unit 13 on a regular basis or in response to a request. The user mobile terminal 3 (the mobile terminal 3A) cooperates with the share car information database server 8 to acquire the share car information.

Thus, the information acquiring unit 101 includes a location information acquiring unit 1011, a vehicle information acquiring unit 1012, a biometric information acquiring unit 1015, and a share car information acquiring unit 1016.

The location information acquiring unit 1011 can acquire the destination information set via the in-vehicle apparatus 2 or the mobile terminal 3A by the user from the in-vehicle apparatus 2 or the mobile terminal 3A via the communication unit 13. The destination information is, for example, information regarding the latitude and longitude of a destination, a facility name, and a facility type.

Moreover, the location information acquiring unit 1011 can acquire, via the communication unit 13, the current location information, the time information, the travelling direction of the vehicle 5, etc., such information being transmitted on a regular basis from the user while the vehicle 5 is travelling. Note that as described later, when the vehicle information acquiring unit 1012 acquires information indicating OFF (engine stop) of an ignition switch of the vehicle 5 or information indicating that a door lock opening/closing signal indicates closing, it is determined that the vehicle 5 has arrived at a predetermined location, and arrival location information (stay location information) can be acquired. Note that the location information acquiring unit 1011 may acquire at least one of the current location information or the destination information.

As described above, the vehicle information acquiring unit 1012 can acquire the vehicle occupant information sensed by the in-vehicle apparatus 2 and including the terminal identification information on each of the mobile terminal 3A and the biometric information acquiring terminal 3B as the user mobile terminals 3 present in the vehicle compartment. Note that the vehicle information acquiring unit 1012 can acquire the latest vehicle occupant information from the in-vehicle apparatus 2 every time the vehicle 5 is started. With this configuration, the information providing apparatus 1 can process, as information from an occupant in the vehicle 5, each piece of information received from the user mobile terminals 3 on the vehicle 5.

Moreover, the vehicle information acquiring unit 1012 can acquire, as the vehicle occupant information, the occupant relationship information regarding a relationship among occupants in the vehicle 5 from the in-vehicle apparatus 2 or the mobile terminal 3A in addition to the occupant scale information regarding the number of occupants in the vehicle 5, as described above. With this configuration, the information providing apparatus 1 can estimate the user attribute of the user in the vehicle 5 and can select the facility notification information matching the user attribute, as described later.

Further, the vehicle information acquiring unit 1012 can acquire, from the in-vehicle apparatus 2 or the mobile terminal 3A, the travelling distance information on the vehicle 5, the velocity information on the vehicle 5, the acceleration information on the vehicle 5, the airbag operation information on the vehicle 5, the vehicle impact information indicating that impact has been applied to the vehicle 5, and the sudden braking information indicating that the brake of the vehicle 5 has been stepped on, as described above. With this configuration, the later-described biometric information of the occupant can be associated with the vehicle information upon measurement of such biometric information.

In addition, the vehicle information acquiring unit 1012 can acquire the vehicle start/stop information on the vehicle 5 and the door lock information on the vehicle 5 from the in-vehicle apparatus 2 or the mobile terminal 3A, as described above. With this configuration, it can be determined whether or not the vehicle 5 has arrived at or left from the destination or the stop therebefore.

Moreover, the vehicle information acquiring unit 1012 can acquire, from the in-vehicle apparatus 2 or the mobile terminal 3A, the external environmental information including, e.g., the air temperature, the humidity, the air pressure, and the brightness outside the vehicle 5 and the internal environmental information including, e.g., the carbon dioxide concentration, the air temperature, the humidity, the air pressure, and the brightness inside the vehicle compartment of the vehicle 5, as described above. With this configuration, the later-described biometric information of the occupant can be associated with external environment and internal environment upon measurement of such biometric information. Accordingly, the later-described facility notification information selection unit 102 can provide the facility information suitable for the biometric information of the occupant and/or the vehicle environmental information, for example.

The biometric information acquiring unit 1015 can acquire, from the biometric information acquiring terminal 3B or the in-vehicle apparatus 2, the biometric information including at least any of the heart rate, the electrocardiogram, the blood pressure, the body temperature, the blood oxygen level, the respiration rate, the respiration cycle, the sweating amount, the pulse amplitude, the blood glucose level, and the sleeping condition in association with, e.g., the body condition of an occupant in the vehicle on a regular basis or in response to a request, as described above. With this configuration, in a case where the user visits a facility, a facility evaluation unit 105 can associate such a facility with the biometric information of the user before, during, and after visit to the facility, and can evaluate a change in such biometric information, as described later.

In a case where there is an occupant as a user having a share car utilization history, the share car information acquiring unit 1016 can make the user mobile terminal 3 (the mobile terminal 3A) of such a user link with the share car information database server 8. With this configuration, the user mobile terminal 3 (the mobile terminal 3A) can determine a facility frequently visited by the share car user from the share car information database server 8. With this configuration, the facility notification information selection unit 102 can preferentially notify the facility notification information if there is a facility frequently visited by the share car user, as described later.

The facility notification information selection unit 102 may carry out a search in the facility information database server 6, and based on, e.g., the user attribute estimated based on the user vehicle occupant information acquired by the information acquiring unit 101 and a facility type or category (“preference information”) with a high degree of suitability, may select the notification information on a facility located within a predetermined distance area from the current location or destination of the vehicle 5 or a facility located within a predetermined distance area from the current location in the travelling direction. Note that the information providing apparatus 1 may include, in the storage unit 11, the preference information storage management table 111 indicating the vehicle occupant information (the user attribute) and the preference information, and therefore, may acquire, as the vehicle occupant information, a facility type or category (“preference information”) with a high degree of suitability.

Alternatively, the user may specify a desired facility type or category (preference information) in advance, and may select the notification information on a facility located in a predetermined distance area from the current location or destination of the vehicle 5 or a facility located in a predetermined distance area from the current location in the travelling direction from facilities matching the specified facility type or category (preference information).

The facility notification information selection unit 102 may estimate the user attribute based on the user vehicle occupant information acquired by the information acquiring unit 101, and may search and select the notification information on a corresponding facility matching the estimated user attribute from the facility information database server 6, for example.

For example, in a case where the facility type or category is a restaurant and the estimated user attribute indicates that the number of users is four and these users are a family with a small child, the facility notification information selection unit 102 extracts a facility whose degree of suitability of service contents (e.g., a menu, a seat layout, and atmosphere) provided by such a restaurant is high for such a user attribute. With this configuration, the notification information on a proper facility can be selected according to the number of occupants and the occupant relationship information.

Note that in a case where the notification information on the selected facility does not reach a predetermined number of candidates or there is no facility, the facility notification information selection unit 102 may expand, e.g., the distance area to select a facility. Preferably, upon expansion of the distance area, such a distance area does not exceed a predetermined length. Note that there are a few facilities located in the vicinity of the current location or the destination in some cases, and for this reason, a case where the number of facilities matching the conditions is less than the predetermined number of candidates is also acceptable.

Facilities in a predetermined distance (e.g., 20 km) area from the vicinity of the current location or destination of the vehicle 5 may be extracted with reference to location information registered on each facility in a facility database. With this configuration, only the facilities in the predetermined distance area from the current location or destination of the vehicle are extracted so that facilities, which are highly unlikely to be selected as the destination by an occupant and are present far from the current location or destination of the vehicle, are not provided as destination candidates to the in-vehicle apparatus 2 or the mobile terminal 3A.

The facility notification information selection unit 102 extracts the facilities in the predetermined distance area from the current location or destination of the vehicle in advance of searching and extraction of facilities having characteristics of an occupant's preferred facility estimated according to an occupant structure, and therefore, the number of facilities targeted for selection can be suppressed small and a load accompanied by the processing of extracting the facilities having the characteristics of the occupant's preferred facility can be reduced.

Only facilities estimated that the vehicle can arrive from the current location of the vehicle within predetermined time (e.g., within one hour) may be extracted. With this configuration, facilities, which are present far from the current location of the vehicle, are not provided as notification information candidates to the user terminal.

The facility notification information selection unit 102 may acquire congestion information on candidate facilities from the facility information database server 6, and based on the current location of the vehicle 5 and the locations of these facilities, may calculate a distance or arrival time to provide such information to the later-described facility information notification unit 103.

The facility information notification unit 103 notifies facility information to the user based on the notification information selected by the facility notification information selection unit 102. Specifically, the facility information notification unit 103 notifies facility information to, e.g., the in-vehicle apparatus 2 of the vehicle 5 that the user is on-board or the mobile terminal 3A carried by the user.

The facility information notification unit 103 may acquire the congestion information on the facilities selected as candidates by the facility notification information selection unit 102 from the facility information database server 6, and may acquire the current location of the vehicle 5 from the location information acquiring unit 1011. Considering the distance or arrival time calculated based on the current location of the vehicle 5 and the locations of these facilities, a facility congestion status (e.g., information on whether or not a crowded state is eased or whether or not there is waiting time), cancellation information, etc., the facility information notification unit 103 may determine whether or not the notification information on these facilities is notified to the user of the vehicle 5. At this point, particularly in the case of the notification information regarding a facility providing a service, the facility information notification unit 103 may also notify the user of the congestion information and the cancellation information.

In a case where there are plural pieces of notification information on the facilities selected by the facility notification information selection unit 102, the facility information notification unit 103 may sequentially notify the user of the facility information, higher priority being given to facilities closer to the current location of the vehicle 5 among the selected facilities.

In a case where the number of pieces of information on neighbor facilities is greater than a predetermined number, if the occupant (the user) carrying the mobile terminal 3A utilizes the share car, the notification information on the facility frequently visited by the share car user in the share car information database server 8 may be preferentially notified.

The facility information notification unit 103 may notify the vehicle occupant information, which includes at least the occupant scale information on the users to which the facility notification information has been notified, to the facility terminal 7 of the facility. With this configuration, a person in charge in the facility can estimate the scale of occupants preferring the facility, the number of occupants which are likely to visit the facility, etc.

In a case where the vehicle 5 stays at the facility (hereinafter also referred to as a “stay facility”) according to the facility notification information, the facility evaluation unit 104 records evaluation information on the stay facility in the storage unit 11. In this case, the user may set the stay facility as the destination, thereby moving to the stay facility according to navigation. In this case, the information acquiring unit 101 acquires the destination information so that the facility evaluation unit 104 can acquire the destination stay facility in advance.

As described above, the information acquiring unit 101 acquires, since the vehicle 5 is started, the vehicle information including the current location information on the vehicle 5, the time information, the travelling direction of the vehicle 5, the velocity information, etc. on a regular basis. When acquiring the information indicating OFF (engine stop) of the ignition switch of the vehicle 5 or the information indicating that the door lock opening/closing signal indicates closing, the information acquiring unit 101 can determine that the vehicle 5 has arrived at the predetermined location.

The facility evaluation unit 104 compares, e.g., the current location information on the vehicle 5 and the location information on the stay facility with each other so that it can be determined that the vehicle 5 has arrived at the destination stay facility. The facility evaluation unit 104 can acquire the arrival time at the stay facility as described above.

At this point, since the information acquiring unit 101 acquires the biometric information on an occupant in the vehicle 5 on a regular basis as described above, the facility evaluation unit 104 can store, as history information, the biometric information of the occupant (referred to as “biometric information before visit to the facility”) until the arrival at the stay facility in the storage unit 11 with the biometric information of the occupant linking the identification information on the vehicle 5, the vehicle occupant information including the occupant scale information, the identification information on the stay facility, and the arrival time at the stay facility. Note that departure time to the stay facility may be also stored. The departure time described herein may be calculated based on time at which the stay facility is set as the destination, time at which the notification information on the stay facility is acquired, or the latest time of the start of the vehicle 5, for example. With this configuration, the facility evaluation unit 104 can take, as the biometric information before visit to the facility, the biometric information acquired between the departure time to the stay facility and the arrival time at the stay facility.

Similarly, the facility evaluation unit 104 can store, as the history information, the biometric information of the occupant (referred to as “biometric information during stay”) acquired on a regular basis by the information acquiring unit 101 during stay at the stay facility together with the time information, the biometric information of the occupant linking the identification information on the stay facility and the arrival time at the stay facility.

Contrary to the time of arrival, the facility evaluation unit 104 acquires, by the information acquiring unit 101, stay facility departure time based on information (information indicating ON (engine start) of the ignition switch of the vehicle 5 or information indicating that the door lock opening/closing signal indicates opening) indicating that the vehicle 5 is started. The biometric information of the occupant (referred to as “biometric information after stay”) acquired on a regular basis for predetermined time after departure can be, together with the time information, stored as the history information, the biometric information of the occupant linking the identification information on the stay facility and the arrival time at the stay facility.

With this configuration, the facility evaluation unit 104 can compare the biometric information of the occupant before and after visit to the facility and the biometric information of the occupant during stay at the facility with each other based on the history information. The facility evaluation unit 104 can evaluate biological influence of the stay facility on the occupant based on a change in the biometric information.

In a case where the biometric information changes in a positive way in terms of the occupant's body condition, the facility evaluation unit 104 determines that the stay facility is good for the body of the user, and records such evaluation on the stay facility in the storage unit 11. Specifically, stay time, the vehicle occupant information including the occupant scale information, and evaluation contents are stored in the storage unit 11 together with the identification information (may be a name or an address) on the stay facility and a facility classification such as a facility type or a category.

Note that in analysis of, e.g., the occupant conversation information after departure from the stay facility, in a case where a favorable keyword (e.g., “tasted good”, “enjoyed”, “fun”, or “want to come again”) for the stay facility is obtained, user's positive evaluation on the stay facility can be estimated. Conversely, in a case where an unfavorable keyword (e.g., “not taste good”, “tasted bad”, “not fun”, or “not want to come again”) for the stay facility is obtained, user's negative evaluation on the stay facility can be estimated based on such a keyword. Based on such information, evaluation may be made in association with a change in the biometric information.

Based on the stay facility evaluation information accumulated as described above, the facility evaluation unit 104 calculates the number of times of stay in every predetermined period (e.g., a month or a year) based on the occupant scale information including the stay facility and the vehicle occupant information so that the preference information corresponding to the vehicle occupant information including can be produced as described above, for example.

The user abnormal state sensing unit 106 senses a biological abnormality of the user based on the biometric information acquired on a regular basis by the biometric information acquiring unit 1015 and including at least any of the heart rate, the electrocardiogram, the blood pressure, the body temperature, the blood oxygen level, the respiration rate, the respiration cycle, the sweating amount, the pulse amplitude, the blood glucose level, and the sleeping condition.

Moreover, the user abnormal state sensing unit 106 senses an anomaly (e.g., an accident) of the vehicle 5 based on the airbag operation information detected by the airbag sensor of the vehicle 5 and indicating that an airbag has been operation or the impact information detected by the impact sensor of the vehicle 5 and indicating that a predetermined level of impact or higher has been applied to the vehicle 5 among the information acquired by the vehicle information acquiring unit 1012 from the in-vehicle apparatus 2.

In a case where the user abnormal state sensing unit 106 does not sense the anomaly of the vehicle 5 and has sensed only the biological abnormality of the user, the emergency processing unit 107 acquires the current location of the vehicle 5 by the location information acquiring unit 1011, acquires information on a medical institution closest to the current location of the vehicle 5 from the facility information database, and displays such information on, e.g., the in-vehicle apparatus 2 and the mobile terminal 3A.

Further, the emergency processing unit 107 as an anomaly information recording management unit records, as anomaly situation history information, the time when the biological abnormality of the user is sensed, the location information on the vehicle 5, and biological abnormality information of the user in the storage unit 11. At this point, such information may be recorded in association with the external environment and the internal environment upon measurement of the biometric information, as described above.

In a case where the user abnormal state sensing unit 106 has sensed the anomaly of the vehicle 5, but has sensed no biological abnormality of the user, the emergency processing unit 107 acquires the current location of the vehicle 5 by the location information acquiring unit 1011, and displays contact information on, e.g., a tow truck or a dealer closest to the current location of the vehicle 5 on, e.g., the in-vehicle apparatus 2 or the mobile terminal 3A.

Further, the emergency processing unit 107 as the anomaly information recording management unit records, as the anomaly situation history information, the time when the anomaly of the vehicle 5 is sensed, the location information on the vehicle 5, and vehicle anomaly information in the storage unit 11.

In a case where the user abnormal state sensing unit 106 has sensed the anomaly of the vehicle 5 and the biological abnormality of the user, the emergency processing unit 107 can automatically make an emergency call, for example. With this configuration, a call to the police or the fire department can be made, and a physician-staffed emergency medical helicopter or car can be dispatched promptly.

Further, the emergency processing unit 107 as the anomaly information recording management unit records, as the anomaly situation history information, the time when the anomaly of the vehicle 5 and the biological abnormality of the user are sensed, the location information acquired on the vehicle 5 by the location information acquiring unit 1011, the anomaly information on the vehicle 5, and the biological abnormality information of the user in the storage unit 11.

With this configuration, an emergency call can be made by simple operation or automatically upon the emergency of the user, and a quick and proper response can be made.

The anomaly statistic recording management unit 109 produces the frequency of occurrence of the user abnormality and area information upon occurrence of the user abnormality based on the information accumulated as the anomaly situation history information in the storage unit 11 and sensed by the user abnormal state sensing unit 106, i.e., the time when the anomaly of the vehicle 5 and/or the biological abnormality of the user is/are sensed, the location information on the vehicle 5, and the vehicle anomaly information and/or the biological abnormality information of the user, and stores such information in the storage unit 11.

With this configuration, an area with a high frequency of occurrence of the anomaly can be analyzed.

Each functional unit of the information providing system 100 of the embodiment of the present invention has been described above based on the configurations of the information providing apparatus 1, the in-vehicle apparatus 2 mounted on the vehicle 5 or the mobile terminal 3A and the biometric information acquiring terminal 3B carried by the user in the vehicle 5, the facility information database server 6, the facility terminal 7, and the share car information database server 8.

### (Operation of Information Providing System 100)

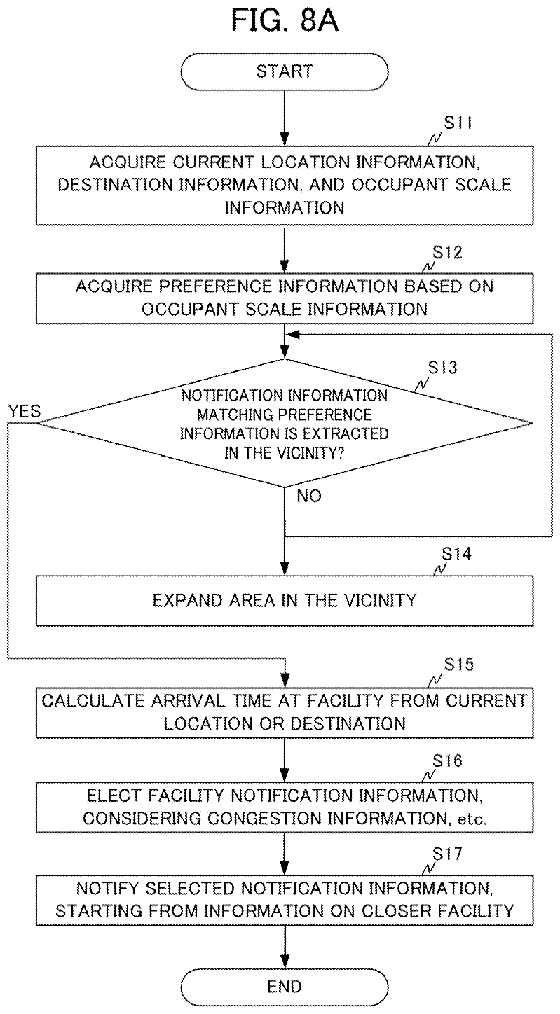

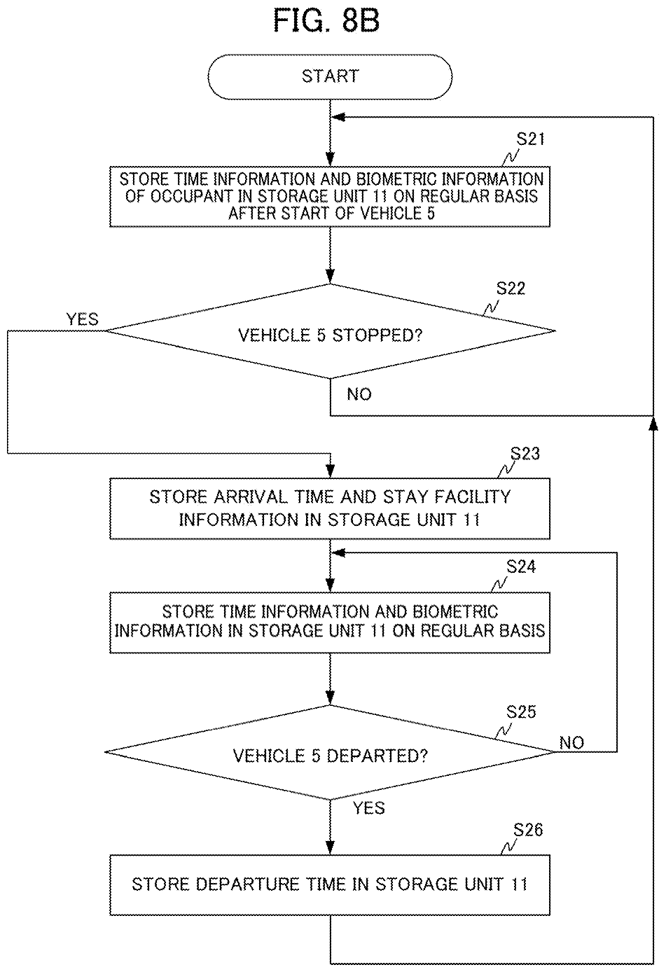

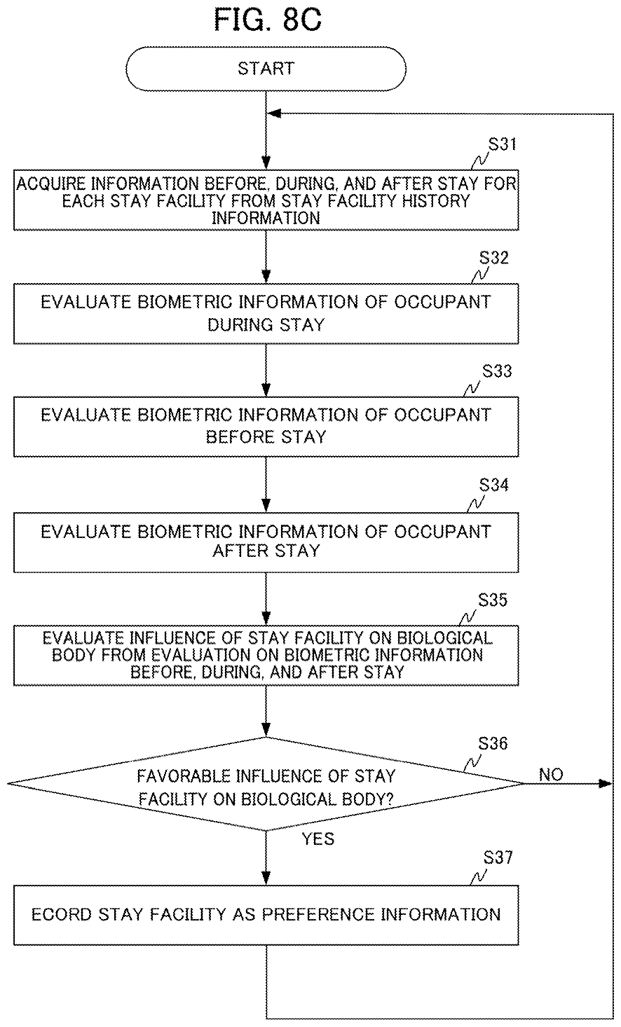

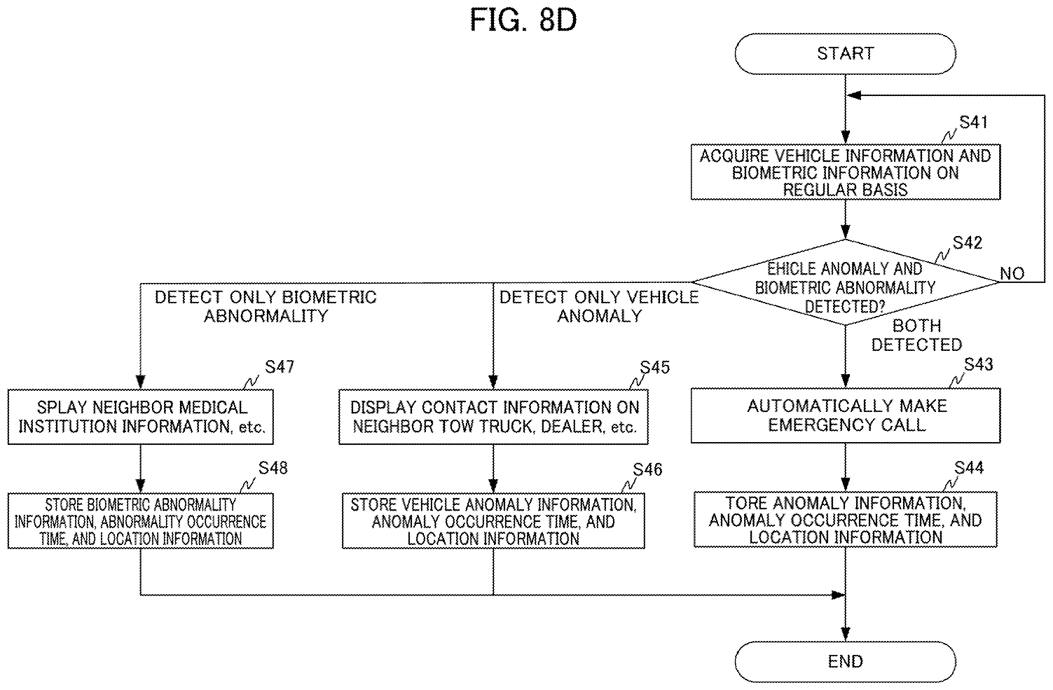

Next, operation of the information providing system 100 will be described, taking the processing of the information providing apparatus 1 as an example. FIGS. 8A to 8C are flowcharts showing the flow of the processing of the information providing apparatus 1.

It is assumed herein that the information providing apparatus 1 acquires information from the in-vehicle apparatus 2 or the user mobile terminal 3 on a regular basis and notifies the facility notification information on a regular basis based on the acquired information.

FIG. 8A shows a processing flow until the information providing apparatus 1 notifies the facility notification information on a regular basis based on the acquired information after having acquired the information from the in-vehicle apparatus 2 or the user mobile terminal 3 for each user in a single processing cycle.

Referring to FIG. 8A, the information providing apparatus 1 (the information acquiring unit 101) acquires, at Step S11, at least one of the current location information or the destination information and the occupant scale information from the in-vehicle apparatus 2 or the user mobile terminal 3.

At Step S12, the information providing apparatus 1 (the facility notification information selection unit 102) acquires the preference information highly matching the occupant in the vehicle 5 based on the occupant scale information.

At Step S13, the information providing apparatus 1 (the facility notification information selection unit 102) carries out a search in the facility information database server 6, and extracts not only the notification information on facilities located in an area in the vicinity (e.g., in a predetermined distance area or an area reachable at predetermined arrival time) of the current location and/or the destination and matching the preference information acquired based on the occupant scale information, but also the congestion information, the cancellation information, etc. In a case where the notification information can be extracted (in the case of YES), the processing proceeds to Step S15. In a case where the notification information cannot be extracted, the processing proceeds to Step S14.

At Step S14, the information providing apparatus 1 (the facility notification information selection unit 102) expands (e.g., add a predetermined increment to the predetermined distance area or the predetermined arrival time) the area in the vicinity (e.g., the predetermined distance area) of the current location and/or the destination, and the processing proceeds to Step S13. Note that although not shown in the figure, in a case where the number of times of such a loop exceeds a preset number of times, such a situation is taken as no notification information acquired, and the notification processing ends.

At Step S15, the information providing apparatus 1 (the facility notification information selection unit 102) calculates the arrival time at each facility extracted at Step S13 from the current location.

At Step S16, the information providing apparatus 1 (the facility information notification unit 103) selects, for each facility, whether or not the notification information is to be notified to the user, considering the congestion information, the cancellation information, etc. on each facility.

At Step S17, the facility notification information selected as being notified at Step S16 is notified to the user. Note that the information providing apparatus 1 (the facility information notification unit 103) may notify the information with a time lag, starting from the information on a facility closer to the vehicle 5 in terms of a distance.

The single processing cycle from selection of the notification information to notification of the notification information to the vehicle 5 is completed as described above.

FIG. 8B shows the processing flow until the information providing apparatus 1 acquires the information from the in-vehicle apparatus 2 or the user mobile terminal 3, and acquires the stay facility history information including the stay facility identification information, the stay facility arrival time, the stay time, the departure time, the biometric information before visit to the facility, the biometric information during stay, and the biometric information after stay based on the acquired information.

Referring to FIG. 8B, the information providing apparatus 1 (the information acquiring unit 101) acquires, at Step S21, not only the vehicle information including, e.g., the time information on the vehicle 5, the travelling direction of the vehicle 5, the velocity information, the ignition switch ON/OFF information, and the door lock opening/closing signal, but also the biometric information on the occupant in the vehicle 5 on a regular basis after the vehicle 5 has been started. The information providing apparatus 1 (the information acquiring unit 101) stores the time information and the biometric information of the occupant in the storage unit 11.

At Step S22, the information providing apparatus 1 (the facility evaluation unit 104) determines whether or not the ignition switch of the vehicle 5 has been turned off (engine stop) or whether or not the door lock opening/closing signal indicates closing. In a case where the ignition switch has been turned off (engine stop) or the door lock opening/closing signal indicates closing (in the case of YES), the processing proceeds to Step S23. In other cases (in the case of NO), the processing proceeds Step S21.

At Step S23, the information providing apparatus 1 (the facility evaluation unit 104) searches a facility, whose facility location information matches a location where the vehicle is stopped, from the facility information database server 6, acquires the arrival time and the stay facility identification information, and stores the arrival time and the stay facility identification information in the storage unit 11.

At Step S24, the information providing apparatus 1 (the facility evaluation unit 104) acquires the time and the biometric information of the occupant from, e.g., the biometric information acquiring terminal 3B on a regular basis, and stores such information in the storage unit 11 with the information linking the stay facility identification information.

At Step S25, the information providing apparatus 1 (the facility evaluation unit 104) acquires the vehicle information on the vehicle 5 on a regular basis, and determines whether or not the ignition switch has been turned on or whether or not the door lock opening/closing signal indicates opening. In a case where the ignition switch has been turned on or the door lock opening/closing signal indicates opening (in the case of YES), the processing proceeds to Step S26. In other cases (in the case of NO), the processing proceeds to Step S24.

At Step S26, the information providing apparatus 1 (the facility evaluation unit 104) stores the stay facility departure time in the storage unit 11 with the stay facility departure time linking the stay facility identification information.

Thereafter, the processing proceeds to Step S21.

As described above, the information providing apparatus 1 (the facility evaluation unit 104) can store, as the history information, the biometric information of the occupant before the vehicle 5 stays at the stay facility, while the vehicle 5 stays at the stay facility, and after the vehicle 5 has departed from the stay facility together with the time information.

FIG. 8C shows the processing flow in which the information providing apparatus 1 (the facility evaluation unit 104) evaluate the influence of the stay facility on the biological body based on the stay facility history information stored in the storage unit 11.

Referring to FIG. 8C, the information providing apparatus 1 (the facility evaluation unit 104) searches, at Step S31, the stay facility history information in chronological order for each user (each vehicle), thereby acquiring stay information on stay at the stay facility.

At Step S32, the information providing apparatus 1 (the facility evaluation unit 104) acquires, from the acquired stay information, the stay facility identification information, the stay time, and the biometric information of the occupant during stay, and evaluates the biometric information of the occupant during stay.

At Step S33, the information providing apparatus 1 (the facility evaluation unit 104) acquires, based on the stay facility history information, the biometric information of the occupant before stay at the stay facility based on the biometric information before stay at the stay facility (e.g., from predetermined time before the stay facility arrival time to the arrival time), and evaluates the biometric information of the occupant before stay.

At Step S34, the information providing apparatus 1 (the facility evaluation unit 104) acquires, based on the stay facility history information, the biometric information of the occupant after stay at the stay facility based on the biometric information after stay at the stay facility (e.g., until a lapse of predetermined time after the stay facility departure time), and evaluates the biometric information of the occupant after stay.

At Step S35, the information providing apparatus 1 (the facility evaluation unit 104) evaluates the influence of the facility on the biological body based on evaluation on the biometric information before, during, and after stay at the facility, and records such evaluation in the storage unit 11.

At Step S36, the information providing apparatus 1 (the facility evaluation unit 104) determines whether or not the influence of the facility on the biological body is favorable. If favorable (in the case of YES), the processing proceeds to Step S37. If unfavorable (in the case of NO), the processing proceeds to Step S31.

At Step S37, the information providing apparatus 1 (the facility evaluation unit 104) stores, as the preference information corresponding to the vehicle occupant information including the occupant scale information, the stay facility providing favorable influence on the biological body in the storage unit 11. Thereafter, the processing proceeds to Step S31.

As described above, the information providing apparatus 1 (the facility evaluation unit 104) can produce the preference information corresponding to the vehicle occupant information based on the stay facility history information on the vehicle 5.

FIG. 8D shows the processing flow the processing flow for automatically taking predetermined action in a case where in determination on the user abnormality, the biological abnormality of the occupant and/or the anomaly of the vehicle 5 have/has been detected.

At Step S41, the information providing apparatus 1 (the information acquiring unit 101) acquires the vehicle information and the biometric information of the occupant from the in-vehicle apparatus 2 or the user mobile terminal 3 on a regular basis before the anomaly information is generated.

At Step 342, the information providing apparatus 1 (the user abnormal state sensing unit 106) determines whether or not the acquired vehicle information indicates, e.g., a vehicle anomaly including airbag deployment or vehicle impact and whether or not an abnormality has been caused in the body of the occupant. In a case where both the vehicle anomaly and the biological abnormality have been detected, the processing proceeds to Step S43. In a case where only the vehicle anomaly has been detected, the processing proceeds to Step S45. In a case where only the biological abnormality has been detected, the processing proceeds to Step S47. In a case where neither the vehicle anomaly nor the biological abnormality has been detected, the processing proceeds to Step S41.

At Step S43, the information providing apparatus 1 (the emergency processing unit 107) acquires the current location information by the information acquiring unit 101, and automatically makes an emergency call.

At Step S44, the information providing apparatus 1 (the emergency processing unit 107) acquires the current location information by the information acquiring unit. 101, and stores, as, e.g., the anomaly situation history information, the time of generation of the vehicle anomaly information and the biological abnormality information and the location information on generation of the vehicle anomaly information and the biological abnormality information in the storage unit 11. Thereafter, the processing may end.

At Step S45, the information providing apparatus 1 (the emergency processing unit 107) acquires the current location information by the information acquiring unit 101, and displays contact information on, e.g., a neighbor tow truck or dealer on, e.g., the in-vehicle apparatus 2 or the mobile terminal 3A.

At Step S46, the information providing apparatus 1 (the emergency processing unit 107) stores, as, e.g., the anomaly situation history information, the time of generation of the vehicle anomaly information and the location information on generation of the vehicle anomaly information in the storage unit 11. Thereafter, the processing may end.

At Step S47, the information providing apparatus 1 (the emergency processing unit 107) acquires the current location information by the information acquiring unit 101, and displays a neighbor medical institution on, e.g., the in-vehicle apparatus 2 or the mobile terminal 3A. Note that a call to an ambulance may be made according to a biological abnormal state.

At Step S48, the information providing apparatus 1 (the emergency processing unit 107) stores, as, e.g., the anomaly situation history information, the time of generation of the biological abnormality information and the location information on generation of the biological abnormality information in the storage unit 11. Thereafter, the processing may end.

The emergency processing when the biological abnormality of the occupant and/or the anomaly of the vehicle 5 have/has been detected has been described above.

The preferred embodiment of the present invention has been described above, but the present invention is not limited to the above-described embodiment and changes can be made as necessary.

### [Variation 1]

In the embodiment of the present invention, the information providing apparatus 1 has been described as, e.g., one server. However, the information providing apparatus 1 may be a distributed processing system for distributing the functions of the information providing apparatus 1 to a plurality of servers as necessary. In this case, the in-vehicle apparatus 2 or the mobile terminal 3A may have some of the functions of the information providing apparatus 1. Alternatively, each function of the information providing apparatus 1 may be implemented utilizing, e.g., a virtual server function on the cloud.

### [Variation 2]

In the embodiment of the present invention, the form in which the in-vehicle apparatus 2 transmits various types of information to the information providing apparatus 1 has been described. However, as another embodiment, it may be configured such that the mobile terminal 3A (e.g., a smartphone) transmits various types of information to the information providing apparatus 1 instead of the in-vehicle apparatus 2.

According to the above-described information providing apparatus 1, the following advantageous effects are provided.

(1) The information providing apparatus 1 can estimate, for the users of the vehicles 5, the preference information changing according to the number of persons taking an action by means of the information on the number of occupants, and can notify the users of the facility information according to the estimated user preference information.

Accordingly, the facility information according to the number of occupants can be provided to, e.g., the users, and user satisfaction is improved. Moreover, for the facility side, the hit rate of hits as a destination to visit is expected to be improved because the notification is made to users having a preference matching the characteristics of the facility.

(2) The information providing apparatus 1 includes the biometric information acquiring unit 1015 that acquires the biometric information of the user, and also includes the facility evaluation unit 104 that evaluates, in a case where the user visits and stays at the facility, the facility from a change in the biometric information of the user before, during, and after stay at the facility.

With this configuration, the information providing apparatus 1 further uses the biometric information of the occupant when selecting the facility information according to the preference information corresponding to the information on the number of occupants, and therefore, can provide the facility information suitable for the biometric information of the occupant.

The information providing apparatus 1 of the present invention can be implemented by hardware, or can be implemented by software.

In other words, the functional configuration of FIG. 7 is merely an example, and is not particularly limited. That is, it may only be required that each type of equipment has the function of executing, as a whole, a series of processing regarding the facility information delivery function of the present invention, and the functional block to be used for implementing such a function is not limited to that in the example of FIG. 7.

One functional block may be implemented by hardware alone, software alone, or a combination thereof.

In a case where a series of processing is executed by software, a program forming such software is installed on, e.g., a computer from a network or a recording medium.

The computer may be a computer incorporated into dedicated hardware. Alternatively, the computer may be a computer capable of executing various functions by installation of various programs.

A recording medium including these programs may include, for example, not only a removable medium distributed separately from an apparatus body for providing the programs to a user, but also a recording medium provided to a user with the recording medium being incorporated into an apparatus body in advance. The removable medium includes, for example, a magnetic disk (including a floppy disk), a Blu-ray Disc (the registered trademark), an optical disk, and a magnetic optical disk. The optical disk includes, for example, a compact disk read only memory (CD-ROM) and a digital versatile disk (DVD). The magnetic optical disk includes, for example, a mini disk (MD). The recording medium provided to the user with the recording medium being incorporated into the apparatus body in advance includes, for example, hard disks included in the storage unit 21 of FIG. 2, the storage unit 31A of FIG. 3, the storage unit 31B of FIG. 4, the storage unit 61 of FIG. 5, and the storage unit 11 of FIG. 7 for recording the programs.

### EXPLANATION OF REFERENCE NUMERALS

100 Information Providing System
1 Information Providing Apparatus
10 Control Unit
101 Information Acquiring Unit
1011 Location Information Acquiring Unit
1012 Vehicle Information Acquiring Unit
1015 Biometric information Acquiring Unit
1016 Share Car Information Acquiring Unit
102 Facility Notification Information Selection Unit
103 Facility Information Notification Unit
104 Facility Evaluation Unit
106 User Abnormal State Sensing Unit
107 Emergency Processing Unit
109 Anomaly Statistic Recording Management Unit
11 Storage Unit
111 Preference Information Storage Management Table
13 Communication Unit
2 In-Vehicle Apparatus
20 Control Unit
201 Vehicle Information Acquiring Unit
202 Environmental Information Acquiring Unit
203 Occupant Information Acquiring Unit
204 User Terminal Cooperation Unit
21 Storage Unit
23 Communication Unit
26 Display Unit
27 Input Unit
3 User. Mobile Terminal
3A Mobile Terminal
30A Control Unit
31A Storage Unit
33A Communication Unit
34A Sensor Unit
36A Display Unit
37A Input Unit
3b Biometric information Acquiring Terminal
30b Control Unit
31b Storage Unit
33b Communication Unit
34b Measurement Unit
36b Display Unit
5 Vehicle
6 Facility Information Database Server
60 Control Unit
61 Storage Unit
63 Communication Unit
7 Facility Terminal
70 Control Unit
71 Storage Unit
73 Communication Unit
8 Share Car Information Database Server

What is claimed is:

1. An information providing apparatus for providing facility information to a user in a vehicle, comprising:
a communication unit;
a storage unit; and
a control unit,
wherein the information providing apparatus is, via the communication unit, communicably connected to a user terminal as a terminal used by the user and a facility information database storing facility notification information including at least a facility name, a facility type, a facility provided service, and facility location information,
the storage unit includes a preference information storage management unit that stores and manages preference information regarding a destination of the user in the storage unit,
the control unit includes
an information acquiring unit that acquires at least one of a current location of the user or the destination of the user from the user terminal via the communication unit,
a notification information selection unit that selects facility notification information to be notified to the user from the facility notification information stored in the facility information database based on at least one of current location information on the user or destination information on the user and the preference information regarding the destination of the user, and
a notification unit that notifies the user terminal of the facility notification information selected by the notification information selection unit,
the information acquiring unit further
acquires, for the user in the vehicle, vehicle occupant information including at least occupant scale information regarding the number of occupants in the vehicle, and
the notification information selection unit further
selects the facility notification information to be notified to the user from the facility notification information stored in the facility information database by means of the user vehicle occupant information acquired by the information acquiring unit.

2. The information providing apparatus according to claim 1, wherein the vehicle occupant information includes at least occupant relationship information regarding a relationship among the occupants in the vehicle.

3. The information providing apparatus according to claim 1, further comprising:
a congestion information acquiring unit that acquires congestion information on a facility located within a predetermined area from the current location or the destination based on the current location information on the user or the destination information on the user,
wherein in a case where the facility notification information selected by the notification information selection unit is information on a facility providing a service, the notification unit notifies the facility notification information together with congestion information on the facility.

4. The information providing apparatus according to claim 1, wherein
the current location of the user is acquired by the information acquiring unit, and
the notification unit preferentially notifies the facility notification information in priority to a user whose distance or movement time calculated based on the current location information on the user and the facility location information is short.

5. The information providing apparatus according to claim 4, wherein
the control unit further includes
a biometric information acquiring unit that acquires biometric information on the user from the user terminal via the communication unit, and
an evaluation unit that evaluates, in a case where the user visits a facility based on the notification information notified to the user by the notification unit, the facility from a change in the biometric information of the user between before and after the visit to the facility.

6. The information providing apparatus according to claim 5, wherein
the control unit further includes
a user abnormal state sensing unit that senses an abnormality, which includes at least worsening of a physical condition or occurrence of an accident of the user based on the biometric information of the user acquired by the biometric information acquiring unit, and
an emergency processing unit that notifies, in a case where a user abnormal state has been sensed by the user abnormal state sensing unit, the user abnormal state to a closest facility based on the user location information.

7. The information providing apparatus according to claim 6, wherein
the information acquiring unit further
acquires vehicle velocity information including at least acceleration information and velocity information on the vehicle, and
the user abnormal state sensing unit
senses the abnormality of the user based on the biometric information of the user acquired by the biometric information acquiring unit and the vehicle velocity information acquired by the information acquiring unit.

8. The information providing apparatus according to claim 6, wherein
the control unit further includes
an anomaly information recording management unit that accumulates, in the storage unit, a date and location information when the user abnormal state sensing unit has sensed the abnormality of the user, and
an anomaly statistic recording management unit that produces a frequency of occurrence of the abnormality of the user and area information on an area where the abnormality has been sensed.

9. The information providing apparatus according to claim 1, wherein
the control unit further includes
a share car information acquiring unit that acquires facility notification information included in a share car information database by cooperation of the user terminal with the share car information database, and
the notification information selection unit further
selects the facility notification information by means of the facility notification information acquired by the share car information acquiring unit.
